(19) United States
(12) Patent Application Publication
(10) Pub. No.: US 2024/0300860 A1
(43) Pub. Date: Sep. 12, 2024

(54) REFRACTORY MATERIALS

(71) Applicant: Honeywell International Inc., Charlotte, NC (US)

(72) Inventors: Kevin Blinn, Franklin Park, NJ (US); Mehrad Mehr, Morristown, NJ (US); Bahram Jadidian, Watchung, NJ (US)

(21) Appl. No.: 18/181,345

(22) Filed: Mar. 9, 2023

(51) Int. Cl. C04B 35/571; C04B 35/626; C04B 35/645

(52) U.S. Cl. CPC C04B 35/571; C04B 35/6263; C04B 35/645; B22D 41/02; C04B 2235/3206; C04B 2235/3208; C04B 2235/3217; C04B 2235/3232; C04B 2235/3244; C04B 2235/3272; C04B 2235/3418; C04B 2235/3427; C04B 2235/349; C04B 2235/3826; C04B 2235/483; C04B 2235/656; C04B 2235/9676

(57) ABSTRACT

A method for forming a refractory component of foundry system includes forming a preform from a refractory mixture. The refractory mixture includes a silicon carbide preceramic polymer and at least one of a refractory powder or refractory aggregate. The method further includes heating the preform to pyrolyze the silicon carbide preceramic polymer and form a refractory material defining the refractory component. The resulting refractory material includes at least one of the refractory powder or the refractory aggregate in a silicon carbide matrix. The refractory component defines an oxidation-resistant surface configured to contact molten metal.

### TECHNICAL FIELD

The disclosure relates to high temperature refractory materials.

### BACKGROUND

Refractory materials may be used in high temperature applications to aid in handling molten metals. For example, in foundries, refractory materials may be used to form or coat metal processing units, such as ladles and furnaces. Due to harsh conditions experienced during metal processing, the metal processing units may undergo corrosion and erosion, which may result in replacement of the entire metal processing unit.

### SUMMARY

The disclosure describes systems and techniques for forming a refractory component from a refractory material. The refractory component may be a portion of a device or system that is subject to a high temperature oxidative environment, such as molten metal processing. The refractory material includes a high temperature refractory powder or aggregate, such as magnesia, alumina, and silica, bonded together by a silicon carbide matrix. The refractory material may be formed from a refractory mixture that includes the refractory powder or aggregate and a silicon carbide preceramic polymer that is pyrolyzed to form the silicon carbide matrix. Prior to pyrolysis, the refractory mixture is formed into a preform, such as by pressing or casting, having a final form of the refractory component. During pyrolysis, the silicon carbide preceramic polymer breaks down to create a silicon carbide matrix that forms robust bonds with the refractory powder or aggregate. After pyrolysis, the refractory component may be incorporated into other structures, such as casings or discs, to support or provide additional functionality to the refractory component. In this way, robust refractory components may be formed in a reduced-step process using relatively inexpensive materials.

In one example, a method for forming a refractory component of a foundry system includes forming a preform from a refractory mixture. The refractory mixture includes a silicon carbide preceramic polymer and at least one of a refractory powder or refractory aggregate. The method further includes heating the preform to pyrolyze the silicon carbide preceramic polymer and form a refractory material defining the refractory component. The resulting refractory material includes at least one of the refractory powder or the refractory aggregate in a silicon carbide matrix. The refractory component defines an oxidation-resistant surface configured to contact molten metal.

In another example, a high temperature article of a foundry system includes a refractory component that defines an oxidation-resistant surface configured to contact molten metal and includes a refractory material. The refractory material includes a polymer-derived silicon carbide matrix and a refractory powder or aggregate in the silicon carbide matrix.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a cross-sectional perspective view diagram illustrating an example vessel that includes a refractory component formed in accordance with the techniques of this disclosure.

FIG. 2 is a cross-sectional expanded view diagram of an example refractory material formed in accordance with the techniques of this disclosure.

FIG. 3 is an expanded view diagram of an example refractory mixture in accordance with the techniques of this disclosure.

FIG. 4 is a flow diagram illustrating an example technique for forming a refractory component in accordance with the techniques of this disclosure.

FIG. 5 is a schematic side view diagram of an example system for forming a refractory component in accordance with the techniques of this disclosure.

### DETAILED DESCRIPTION

The disclosure describes high temperature articles of foundry systems that include a refractory material having high temperature refractory powder bonded in a robust silicon carbide matrix. Refractory components made from refractory materials may be capable of operating in high temperature oxidative environments. For example, foundry refractory materials may aid in the handling of molten metals during metalworking, such as steelmaking. Various foundry systems, such as ladles, slide gates, and furnaces, may include refractory components, such as bulk materials or liners, to assist in maintaining high temperatures of the molten metals and shield more sensitive components of the processing units and workers operating the processing units from the high temperatures. These refractory components may provide high resistance to oxidation and/or environmental attack at high temperatures experienced during fabrication of aerospace components.

Rather than form the refractory materials from a single refractory ceramic material, which may require very high processing temperatures that may limit furnace size, refractory materials may be formed from refractory ceramic particles dispersed in a ceramic matrix. The ceramic matrix may form at temperatures below a melt or sintering temperature of the refractory ceramic material to bond together the refractory ceramic particles. However, despite a relatively high thermal and chemical stability of the refractory materials, the harsh environment of the molten metals may erode and corrode the ceramic matrix of the refractory components. For example, ladles for processing steel may be formed from refractory materials that include refractory particles bonded by a carbon matrix. Slag and other byproducts of steel processing may oxidize the carbon and cause cracking or other degradation in the refractory materials. As a result, the refractory components may be periodically replaced or rebuilt.

Refractory components described herein may be formed from a refractory material using a relatively simple, inexpensive process. The refractory material includes a high temperature refractory powder or aggregate bonded together by a silicon carbide matrix. The silicon carbide matrix may resist oxidation at high temperatures and may be stable up to relatively high temperatures, such as greater than about 1500° C. The refractory material may have various compositional properties, such as powder size and distribution, powder composition, and volume ratio of powder to preceramic polymer to provide particular thermomechanical and thermophysical properties to the refractory material, such as coefficient of thermal expansion, porosity, thermal conductivity, or thermal stability (e.g., melting point). For example, the volume fraction of the silicon carbide matrix may be relatively low (e.g., less than 10 percent by volume), such that the silicon carbide matrix bonds the refractory powder or aggregate together while maintaining a high volume fraction of the more inexpensive, temperature resistant, and oxidation resistant refractory powder or aggregate.

Refractory components described herein may be formed as a unitary component from a workable and fluid refractory mixture. The refractory mixture includes the refractory powder or aggregate and a silicon carbide preceramic polymer. The refractory powder or aggregate may be relatively inexpensive and readily available, while the silicon carbide preceramic polymer may be a relatively small portion of the refractory mixture (e.g., less than about 20 percent by weight). The refractory mixture may have various fluid and compositional properties, such as viscosity, packing density, and volume ratio of solid component (e.g., powder) to liquid component (e.g., preceramic polymer and solvent), that enable the refractory mixture to be formed into a compacted preform having a predetermined shape that resists dimensional changes during heat treatment. The refractory mixture may include additional components configured to aid in forming a robust refractory material, such as a solvent for tailoring a viscosity of the refractory mixture. After formation of the preform, the preform may be dried and heated to pyrolyze the preceramic polymer into a silicon carbide matrix.

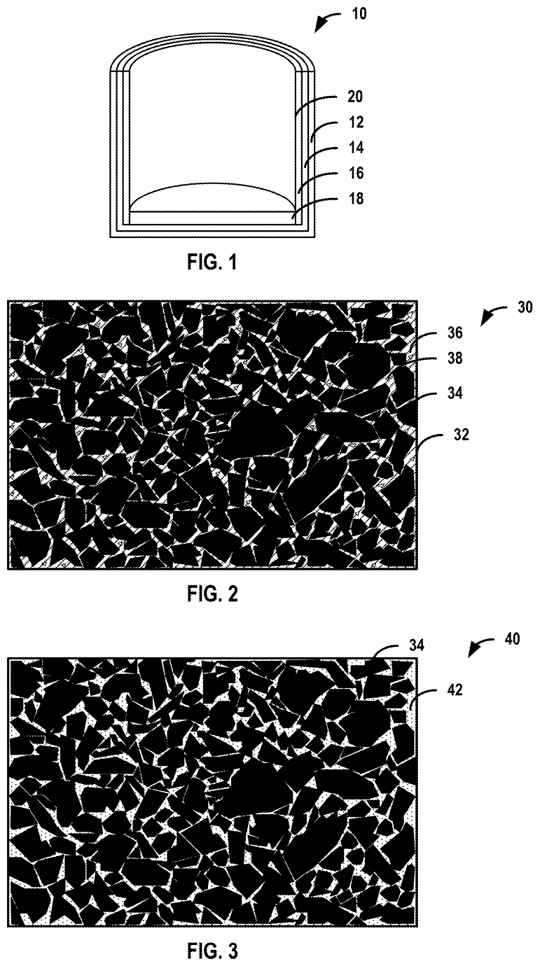

Refractory components described herein may be used in a variety of high temperature applications. FIG. 1 illustrates an example of a high temperature vessel 10 configured to handle molten materials. Such high temperature articles may include one or more surfaces that contact molten metal and experience high temperatures conducive to oxidation, and so may include refractory components to resist oxidation. FIG. 1 is a cross-sectional perspective view diagram illustrating an example vessel 10 that includes a refractory component 16 formed in accordance with the techniques of this disclosure. Vessel 10 includes a casing 12, an insulating layer 14, refractory component 16, and a bottom 18 that may include a heating system (not shown). Vessel 10 may be configured to process molten metal, such as such as steels. For example, vessel 10 may be a crucible for melting metal or a ladle for transporting molten metal. Surfaces of vessel 10 in contact with molten metal may experience oxidation and corrosion due to impurities in the metal. For example, melting various metals used for steel may cause calcium and silicon to come into solution and form byproducts such as calcium-rich silicates.

To resist corrosion and oxidation from these byproducts, vessel 10 includes refractory component 16. Refractory component 16 may form at least a portion of an interior portion of vessel 10, and may include an oxidation-resistant surface 20 configured to contact molten metal. As will be discussed further below, refractory component 16 is fabricated as a refractory material that includes a refractory powder or aggregate in a silicon carbide matrix. The refractory powder or aggregate defines a dispersed phase that resists very high temperatures, while the silicon carbide matrix defines a continuous phase that bonds together the refractory powder or aggregate and is chemically stable in the presence of reactive byproducts of the molten metal.

FIG. 2 is a schematic side view diagram of a portion of an example refractory material formed in accordance with the techniques of this disclosure. The refractory material may be a portion of a refractory component 30, such as refractory component 16 of FIG. 1, subject to high temperatures and oxidative conditions during operation. As one example, as described in FIG. 1 above, metal processing components may be exposed to temperatures above 2200 degrees Fahrenheit (° F.) (about 1200 degrees Celsius (° C.)) during processing of superalloys.

The refractory material includes a polymer-derived silicon carbide matrix 36 and a refractory powder or aggregate 34 in silicon carbide matrix 36. Refractory powder or aggregate 34 may form a tightly packed phase having a high volume fraction of the refractory material. Silicon carbide matrix 36 may form a binding phase having a low volume fraction of the refractory material.

Polymer-derived silicon carbide matrix 36 may include a silicon carbide ceramic material formed from decomposition of a preceramic polymer and subsequent formation of an amorphous and/or crystalline phase that maintains thermal and chemical stability at high temperatures, such as above about 1500° C. Silicon carbide may have properties that are particularly suited for a high temperature oxidative environment, including a high decomposition temperature, a relatively low crystallization temperature for one or more crystalline phases of the polymer-derived ceramic material, a low coefficient of thermal expansion, ability to form a passivating oxide layer, and compatibility and adhesion with the refractory powder or aggregate 34.

In some examples, silicon carbide matrix 36 may be present as a substantially (e.g., greater than 95% by volume) crystalline phase. As will be explained further below, silicon carbide matrix 36 may be substantially crystallized by heating silicon carbide matrix 36 above a crystallization temperature after pyrolysis of the preceramic polymer, such that silicon carbide matrix 36 is substantially free of glass/amorphous phases. For example, silicon carbide matrix 36 may include one or more crystalline phases distributed in an amorphous phase, such that the amorphous phase is less than about 5% by volume of the ceramic matrix.

Silicon carbide matrix 36 may be present in the refractory material in a distribution and volume fraction sufficient to bond particles of refractory powder or aggregate 34 together. For example, refractory powder or aggregate 34 may form a tightly packed aggregate with small voids between particles. Silicon carbide matrix 36 may fill these voids to secure and seal the particles. However, while silicon carbide matrix 36 may have high thermal and oxidative resistance, refractory power or aggregate 34 may have a higher thermal and/or oxidative resistance, such that a volume fraction of silicon carbide matrix 36 may be kept relatively small. In some examples, silicon carbide matrix 36 defines less than about 10 percent by volume of the refractory material.

Refractory powder or aggregate 34 may include any high temperature refractory ceramic material. A high temperature refractory ceramic material may include any ceramic material that maintains thermal and chemical stability at temperatures above about 1500° C. A composition of refractory powder or aggregate 34 may be selected for a variety of properties including, but not limited to, a melting point of the ceramic material, a coefficient of thermal expansion of the ceramic material, a thermal conductivity of the ceramic material, compatibility with a selected polymer-derived ceramic matrix, and the like. For example, a melting or softening point of refractory powder or aggregate 34 may be higher than an anticipated temperature encountered by refractory component 30 during operation. In some examples, refractory powder or aggregate 34 may have a melting point greater than about 1600° C., such as greater than about 2400° C. Example ceramic materials may include, but are not limited to, magnesium oxide (magnesia), aluminum oxide (alumina), silicon oxide (silica), calcium oxide (calcia), ferric oxide, titanium oxide (titania), silicates, zirconia, chamotte, combinations thereof, and other refractory ceramic materials. In some examples, the refractory powder or aggregate 34 includes at least one of magnesium oxide or a rare earth silicate. As one example, magnesium oxide formed at high temperatures (e.g., greater than 1500° C.) may be physically and chemically stable at high temperatures experienced during metal processing, and may be relatively inexpensive and easily obtained.

Refractory powder or aggregate 34 may be present as a powder that includes relatively loose particles or an aggregate that includes relatively constrained (e.g., packed) particles. Various parameters of the particles, such as particle size, particle shape, and particle size distribution of refractory powder or aggregate 34 may be selected such that refractory powder or aggregate 34, once bonded in silicon carbide matrix 36, forms a tightly packed, mechanically robust composite. In some examples, particle sizes may be from about 0.1 micrometers to about 500 micrometers.

In some examples, the refractory material may be configured with a particular average particle size or shape and/or a particle size distribution of refractory powder or aggregate 34 within silicon carbide matrix 36. A density of the refractory material may be related to a compaction or packing density of refractory powder or aggregate 34. To increase the density of the refractory material and enhance its properties, (e.g., pyrolysis, and optionally, crystallization), a refractory mixture used to form the refractory material may include an extended distribution of particles sizes, such as a bimodal or trimodal distribution of particle sizes. A bimodal or trimodal particle size distribution may be configured to form a highly packed refractory material and increase the overall density of the materials and performance. The particle size distribution may vary based on a composition of the refractory powder or aggregate 34 and volume ratio of refractory powder or aggregate 34 to silicon carbide matrix 36. The distribution will determine packing. In some examples, a packing factor may be at least about 60% by volume, such as from about 60% to about 75%, depending on particle size distribution.

The refractory material may be configured to maintain a near net shape of refractory component 30 before and after processing. Refractory component 30 having a near net shape may have no or little shrinkage during pyrolysis. For example, prior to pyrolysis, a preform formed from a refractory mixture that includes refractory powder or aggregate 34 may be defined by a first volume corresponding to a first set of dimensions of the corresponding mold. After pyrolysis, refractory component 30 may be defined by a second volume corresponding to a final shape of refractory component 30. A near net shape may be a difference between the first volume and the second volume that is less than about five percent by volume.

Prior to pyrolysis, refractory powder or aggregate 34 may be densely packed, such that grains of particles of refractory powder or aggregate 34 contact grains of adjacent particles. During pyrolysis of the silicon carbide preceramic polymer, the silicon carbide preceramic polymer may decompose into a higher density silicon carbide matrix. In a refractory mixture in which the refractory particles are not tightly packed, the refractory component may shrink and maintain a high density with a relatively low porosity. However, in a refractory mixture in which particles of refractory powder or aggregate are tightly packed, the grains of the particles may continue to reinforce the shape of the refractory material.

In contrast, refractory materials described herein may maintain a near net shape of refractory component 30 by resisting shrinkage. During pyrolysis, the silicon carbide preceramic polymer may locally shrink to form silicon carbide matrix 36, and may include small pores 38 such that the refractory material may have slightly lower density. In some examples, the refractory material may include a porosity of pores 38 that is substantially closed, such as greater than about 80 percent by volume closed pores. In this way, by tightly packing particles of refractory powder or aggregate 34, refractory component 30 may have a high density, enhanced mechanical properties, near net shape, a relatively high proportion of closed pores, and/or a low amount of relatively expensive silicon carbide matrix.

In some examples, the refractory material may include more than one particle composition of refractory powder or aggregate 34. Various properties of the refractory material, such as effective coefficient of thermal expansion, may result from a combination of properties of refractory powder or aggregate 34 and silicon carbide matrix 36. A particular composition of refractory powder or aggregate 34 may have particular chemical and thermal properties, such as melting point and coefficient of thermal expansion, that may be more suitable for particular operating conditions. In some examples, refractory powder or aggregate 34 may include a mix of more than one species, such that the corresponding refractory material may have properties resulting from a blend of refractory powders or aggregates 34. For example, a mix of more than one species may be configured to enhance thermal shock, by include a blend of refractory powders or aggregates 34 having different elastic moduli, thermal conductivities, and/or thermal expansion coefficients to produce a refractory material having a particular bulk elastic modulus, thermal conductivity, and/or thermal expansion. In some examples, refractory powder or aggregate 34 may include active species configured to interact with other species. For example, a mix of more than one species may include a species configured to react with oxidative species, such as oxygen. In some examples, a mix of more than one species may be configured to produce a refractory material at a particular grade associated with a price point. For example, a mix of more than one species may balance a cost of the various species with a quality (e.g., strength or stability) of the refractory material.

In some examples, the refractory material may include a particular volume ratio of silicon carbide matrix 36 to refractory powder or aggregate 34. As mentioned above, the volume ratio of silicon carbide matrix 36 to refractory powder or aggregate 34 may be kept relatively small to maintain a high amount of the more chemically and thermally stable refractory powder or aggregate 34 and/or to reduce a cost of the refractory material. For example, silicon carbide preceramic polymers may be relatively expensive, such that by maintaining a relatively low amount of silicon carbide matrix 36 sufficient to bind together refractory powder and/or aggregate 34, a cost of the refractory material may be relatively low. Such relatively low cost may be particularly important for components of foundry systems, which may use large amount of the refractory material in a piece of equipment that may have a high replacement schedule. In some examples, silicon carbide matrix 36 may define less than about 5 percent by volume of the refractory material, while refractory powder or aggregate may define greater than 90 percent by volume of the refractory material.

Refractory materials are formed from a refractory mixture that includes refractory powder or aggregate 34. FIG. 3 is an expanded view diagram of an example refractory mixture in accordance with the techniques of this disclosure. Refractory mixture 40 includes a liquid component 42 and a refractory powder or aggregate 34 dispersed in the liquid component.

Liquid component 42 includes a silicon carbide preceramic polymer. a silicon carbide ceramic material formed from decomposition of a preceramic polymer and subsequent formation of an amorphous and/or crystalline phase that maintains thermal and chemical stability at high temperatures, such as above about 1500° C. Preceramic polymers may be relatively inexpensive for forming a silicon carbide matrix compared to chemical and physical deposition methods, such as chemical vapor deposition (CVD). The preceramic polymer may be selected for cost and desired properties of a resulting pyrolyzed, and optionally crystallized, silicon carbide matrix, such as silicon carbide matrix 36 of FIG. 2. A variety of preceramic polymers may be used including, but not limited to, polysilanes; polycarbosilanes, such as allylhydridopolycarbosilane (AHPCS); polysiloxanes; polycarbosiloxanes; polysilazanes; polycarbosilazanes; and the like.

In some examples, the preceramic polymer may be selected for desired properties of refractory mixture 40 or a preform formed from refractory mixture 40. For example, the preceramic polymer may be selected for fluid properties related to an ability of refractory mixture 40 to flow during application to a mold, fluid or adhesive properties related to an ability of refractory mixture 40 to compact and maintain a compacted form as a preform prior to complete pyrolysis, and other properties related to dispersion and compaction of refractory mixture 40.

In some examples, the preceramic polymer may be configured to aid in adhesion of a preform formed from the refractory mixture. For example, the preceramic polymer may function as a binder to adhere the refractory mixture in the desired shape as the preform prior to pyrolysis of the preceramic polymer. The preceramic polymer may wet surfaces of refractory powder or aggregate 34 and bind refractory powder or aggregate 34. As a result, the preform formed from the compacted refractory powder or aggregate 34 and the preceramic polymer may be structurally solid to resist at least forces from gravity and light handling.

In some examples, the preceramic polymer may be cured prior to fully pyrolysis, such as through heating, to form a hardened preform having reduced brittleness. For example, while compaction may form the refractory mixture into a preform having a compacted consistency, the preform may still be brittle and prone to damage in response to drops or rough handling. A portion of the preceramic polymer, such as a portion near a surface of the refractory component, may be heated above a curing temperature to cure the portion of the preceramic polymer and protect the preform from damage. In some examples, the curing temperature may be greater than about 100° C. and less than about 250° C., and may be dependent on the particular preceramic polymer.

Refractory mixture 40 is configured to be cast into a preform that is subsequently heated. The preform may have a predetermined shape generally corresponding to a final shape of a refractory component. As such, refractory mixture 40 may have various flow properties related to an ability of refractory mixture 40 to flow or move into a mold and/or various adhesion properties related to an ability of refractory mixture 40 to form preform after pressurization. As one example, for a component with relatively complex features, refractory mixture 40 may have a relatively low viscosity, such that refractory mixture 40 may be injected into the mold and flow into portions of the mold having the relatively complex features. On the other hand, for a component with relatively simple features, refractory mixture 40 may have a relatively high viscosity, such that refractory mixture 40 may be compacted, such as with a pellet press, into the mold.

In some examples, refractory mixture 40 may have a particular ratio of liquid component 42 to refractory powder or aggregate 34. The ratio of liquid component 42 to refractory powder or aggregate 34 may be related to a number of flow or adhesion properties of refractory mixture 40, such as viscosity and/or dispersibility. For example, the ratio of liquid component 42 to refractory powder or aggregate 34 may be sufficiently high that the preceramic polymer and refractory powder or aggregate 34 may be evenly distributed throughout refractory mixture 40; sufficiently high that refractory mixture 40 may flow into a mold; and/or sufficiently low that refractory mixture 40 may maintain a solid, compacted preform after compaction and prior to complete pyrolysis. In some examples, refractory mixture 40 has a volume ratio of liquid component 42 to refractory powder or aggregate 34 that is less than about 1:5.

In some examples, liquid component 42 may include a solvent. The solvent may be configured to aid in dispersal of the refractory mixture. For example, while increasing a proportion of preceramic polymer in refractory mixture 40 may reduce a viscosity of refractory mixture 40, this higher proportion may result in a higher volume fraction of silicon carbide matrix 36. Inclusion of the solvent may control a viscosity of refractory mixture 40 without substantially contributing to a volume fraction of the refractory material. For example, the solvent may be configured to be removed during processing of the refractory material, such as during heat treatment. As one example, for a component with relatively complex features, refractory mixture 40 may include a high amount of solvent in liquid component 42 to reduce a viscosity of refractory mixture 40 to flow into portions of the mold having the relatively complex features. As another example, for a component with relatively simple features, refractory mixture 40 may include a low amount of solvent in liquid component 42 to increase a viscosity of refractory mixture 40 to reduce an amount of solvent to be removed during drying.

In some examples, the solvent may be configured to aid in dispersal of refractory powder or aggregate 34 and/or the preceramic polymer in refractory mixture 40. For example, the preceramic polymer may represent a relatively small volume fraction of refractory mixture 40 compared to refractory powder or aggregate 34. As such, creation of a homogeneous mixture of refractory powder or aggregate 34 and the preceramic polymer may be difficult, as the preceramic polymer may not adequately fill voids between particles of refractory powder or aggregate 34. Inclusion of a solvent may assist in expanding the preceramic polymer and fluidizing refractory mixture 40 such that refractory mixture 40 may be well-mixed and substantially homogeneous. The solvent may be removed prior to or during compaction to create a substantially homogeneous mixture of refractory powder or aggregate 34 and the preceramic polymer.

Solvents may be selected for a variety of properties including, but not limited to, viscosity, surface tension or contact angle, reactivity, compatibility with the preceramic polymer, affinity with the preceramic polymer (e.g., expansion of polymer), boiling point, and the like. For example, a solvent with a low viscosity, low surface tension or contact angle, high affinity with the preceramic polymer, and low boiling point may increase flowability of refractory mixture 40, increase wettability of the preceramic polymer, increase swelling of refractory mixture 40, and reduce solvent removal time, respectively. A variety of solvents may be used including, but not limited to, aqueous solvents; non-aqueous solvents, such as hydrocarbons, ethers, ketones, esters, aldehydes, alcohols, amines, or carboxylic acids; and the like. In some examples, liquid component 42 may also include a dispersant with the solvent.

In some examples, a composition, particle size or shape, and/or particle size distribution of refractory mixture 40 may be selected to produce a resulting refractory material that is relatively free of thermal defects, such as cracking caused by changes in temperature during pyrolysis or crystallization. For example, during pyrolysis of the preceramic polymer, the preceramic polymer may change dimension due to shrinkage from release of various volatiles, thermal expansion, or other dimensional change due to temperature. This dimensional change may be different than a dimensional change of refractory powder or aggregate 34, such as due to a different coefficient of thermal expansion or a relatively lower chemical stability of the preceramic polymer. As such, refractory mixture 40 used to form the refractory material may be configured to with a composition, particle size or shape, and/or particle size distribution such that, during various processing steps, such as casting, pressurizing, drying, and/or heating, the refractory material and various intermediates of the refractory material may not experience degradation.

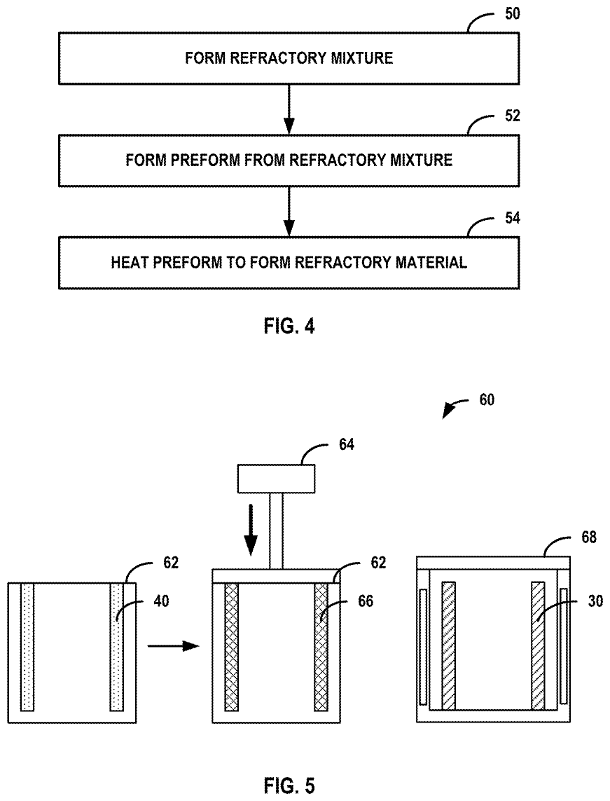

FIG. 4 is a flow diagram illustrating an example technique for forming a refractory component, while FIG. 5 is a schematic side view diagram of an example system for forming a refractory component, in accordance with the techniques of this disclosure.

The method includes forming a refractory mixture (50), such as refractory mixture 40 of FIG. 3. Refractory mixture 40 includes a silicon carbide preceramic polymer and a refractory powder or aggregate. Refractory mixture 40 may be formed by mixing the silicon carbide preceramic polymer, refractory powder or aggregate 34, and any solvents and/or dispersants. In some examples, the silicon carbide preceramic polymer is present in an amount such that a resulting silicon carbide matrix defines less than about 10 percent by weight of the refractory material, such as less than about 20 percent by weight. Refractory mixture 40 may include a proportion of a solvent sufficient to substantially mix refractory mixture 40 into a well-dispersed mixture, and may depend on the particular preceramic polymer and method of mixing. In some examples, the solvent is present at a concentration greater than about 5 percent by volume, such as from about 5 percent by volume to about 10 percent by volume.

In some examples, a proportion of solvent in refractory mixture 40 may be modified to tailor the viscosity of refractory mixture 40. For example, an amount of solvent ideal for evenly mixing refractory mixture 40 may be different from an amount of solvent ideal for dispersing refractory mixture 40 into a mold or other form. As such, an amount of solvent may be added or removed to provide a desired consistency of refractory mixture 40 prior to forming a preform.

The method includes forming a preform from the refractory mixture (52). Initially, the refractory mixture may include refractory powder or aggregate 34, the preceramic polymer, and optionally the solvent or dispersant, as a fluid or paste. To form the preform, refractory mixture 40 may be compacted to compress refractory powder or aggregate 34 and increase a density refractory mixture 40.

In some examples, forming the preform from the refractory mixture includes pressure casting the refractory mixture into a predetermined shape of the preform. Referring to FIG. 5, a system 60 may include a mold 62 configured to receive refractory mixture 40. Mold 62 may include a cavity 63 having a predetermined shape that generally corresponds to a final shape of the refractory component. System 60 may also include a pressurization system 64 configured to pressurize refractory mixture 40 in mold 62. Pressure casting refractory mixture 40 may include applying refractory mixture 40 into mold 62 having the predetermined shape and compressing, using pressurization system 64, refractory mixture 40 in mold 62 to at least partially cure refractory mixture 40 into a preform 66.

The method includes heating preform 66 to form a refractory component 30 (54). Referring to FIG. 5, system 60 may include a furnace 68 configured to heat preform 66. Furnace 68 may heat preform 66 to a heat treatment temperature in an inert atmosphere or under vacuum. The heat treatment temperature is sufficiently high to pyrolyze the preceramic polymer of preform 66 and form silicon carbide matrix 36. For example, a typical silicon carbide preceramic polymer, such as AHPCS, may begin to pyrolyze at about 450° C. and fully pyrolyze by 900° C. The heating of preform 66 at least partially, e.g., substantially fully pyrolyzes, the silicon carbide preceramic precursor. The decomposition of the preceramic polymer to the silicon carbide matrix may result in shrinkage of the preceramic polymer. For example, the preceramic polymer may decompose from a density, such as about 1 gram/centimeter (g/cm) into amorphous silicon carbide having a density of about 2.5 g/cm.

In some example processes, the heat treatment temperature may also be sufficiently high to crystallize silicon carbide matrix 36. Continuing with the example of AHPCS above, the silicon carbide matrix may be heated above 900° C. and begin crystallizing at about 1200° C., with full crystallization occurring at about 1500° C.-1600° C. The heat treatment temperature may be sufficiently high to convert most or all of a glassy phase into one or more crystalline phases. In some examples, heat treatment temperature may be greater than about 950° C. for several hours, such as about 1425° C. The resulting refractory material includes the refractory powder or aggregate 34 in silicon carbide matrix 36.

While illustrated in FIG. 5 as involving different equipment, in some examples, heating preform 66 may include, after pressure casting refractory mixture 40, heating preform 66 in mold 62. For example, mold 62 may be configured to heat preform 66 to a pyrolysis temperature of the preceramic polymer to complete the heat treatment and consolidate refractory powders and/or aggregates 34 with silicon carbide matrix 36 into a finished component.

Example 1: A method for forming a refractory component of a foundry system includes forming a preform from a refractory mixture, wherein the refractory mixture comprises: a silicon carbide preceramic polymer; and at least one of a refractory powder or refractory aggregate; and heating the preform to pyrolyze the silicon carbide preceramic polymer and form a refractory material defining the refractory component, wherein the refractory material comprises at least one of the refractory powder or the refractory aggregate in a silicon carbide matrix, wherein the refractory component defines an oxidation-resistant surface configured to contact molten metal.

Example 2: The method of example 1, wherein the silicon carbide matrix defines less than about 10 percent by volume of the refractory material.

Example 3: The method of any of examples 1 and 2, wherein the refractory powder or aggregate comprises at least one of magnesia, alumina, silica, calcia, ferric oxide, titania, silicates, zirconia, or chamotte.

Example 4: The method of any of examples 1 through 3, wherein the preform is defined by a first volume, wherein the refractory component is defined by a second volume, and wherein a difference between the first volume and the second volume is less than about five percent by volume.

Example 5: The method of any of examples 1 through 4, wherein forming the preform from the refractory mixture comprises: applying the refractory mixture into a mold having a predetermined shape; and compressing the refractory mixture in the mold.

Example 6: The method of example 5, wherein heating the preform further comprises, after pressure casting the refractory mixture, heating the preform in the mold.

Example 7: The method of any of examples 1 through 6, wherein the refractory mixture further comprises a solvent.

Example 8: The method of example 7, wherein the preceramic polymer and the solvent define a liquid component of the refractory mixture, and wherein a ratio of the liquid component to the refractory powder or aggregate is less than about 1:5.

Example 9: The method of any of examples 1 through 8, wherein heating the preform further comprises heating the silicon carbide preceramic polymer above a pyrolysis temperature to pyrolyze the silicon carbide preceramic polymer into the silicon carbide matrix.

Example 10: The method of example 9, wherein heating the preform further comprises heating the silicon carbide matrix above a crystallization temperature to crystallize the silicon carbide matrix.

Example 11: The method of any of examples 1 through 10, further comprising forming the refractory mixture by mixing the silicon carbide preceramic polymer and the refractory powder or aggregate.

Example 12: The method of any of examples 1 through 11, wherein a melting point of the refractory powder or aggregate is greater than about 1500 degrees Celsius (° C.).

Example 13: The method of any of examples 1 through 12, wherein the refractory component comprises an interior portion of a vessel for contacting molten metal.

Example 14: The method of any of examples 1 through 13, wherein the refractory component comprises at least one of a ladle, a slide gate, or a liner.

Example 15: A high temperature article of a foundry system includes a refractory component defining an oxidation-resistant surface configured to contact molten metal, wherein the refractory component comprises a refractory material, and wherein the refractory material comprises: a polymer-derived silicon carbide matrix; and at least one of a refractory powder or refractory aggregate in the silicon carbide matrix.

Example 16: The high temperature article of example 15, wherein the silicon carbide matrix comprises less than about 10 percent by volume of the refractory component.

Example 17: The high temperature article of any of examples 15 and 16, wherein the refractory powder or aggregate comprises at least one of magnesia, alumina, silica, calcia, ferric oxide, titania, silicates, zirconia, or chamotte.

Example 18: The high temperature article of any of examples 15 through 17, wherein a melting point of the refractory powder or aggregate is greater than about 1500 degrees Celsius (° C.).

Example 19: The high temperature article of any of examples 15 through 18, wherein the high temperature article comprises a vessel, wherein the refractory component comprises an interior portion of the vessel, and wherein the oxidation-resistant surface of the refractory component is configured to contact molten metal.

Example 20: The high temperature article of any of examples 1 through 19, wherein the refractory component comprises at least one of a ladle, a slide gate, or a liner.

Various examples have been described. These and other examples are within the scope of the following claims.

What is claimed is:

1. A method for forming a refractory component of a foundry system, comprising:
forming a preform from a refractory mixture, wherein the refractory mixture comprises:
a silicon carbide preceramic polymer; and
at least one of a refractory powder or refractory aggregate; and
heating the preform to pyrolyze the silicon carbide preceramic polymer and form a refractory material defining the refractory component, wherein the refractory material comprises at least one of the refractory powder or the refractory aggregate in a silicon carbide matrix,
wherein the refractory component defines an oxidation-resistant surface configured to contact molten metal.

2. The method of claim 1, wherein the silicon carbide matrix defines less than about 10 percent by volume of the refractory material.

3. The method of claim 1, wherein the refractory powder or aggregate comprises at least one of magnesia, alumina, silica, calcia, ferric oxide, titania, silicates, zirconia, or chamotte.

4. The method of claim 1,
wherein the preform is defined by a first volume,
wherein the refractory component is defined by a second volume, and
wherein a difference between the first volume and the second volume is less than about five percent by volume.

5. The method of claim 1, wherein forming the preform from the refractory mixture comprises:
applying the refractory mixture into a mold having a predetermined shape; and
compressing the refractory mixture in the mold.

6. The method of claim 5, wherein heating the preform further comprises, after compressing the refractory mixture, heating the preform in the mold.

7. The method of claim 1, wherein the refractory mixture further comprises a solvent.

8. The method of claim 7,
wherein the preceramic polymer and the solvent define a liquid component of the refractory mixture, and
wherein a ratio of the liquid component to the refractory powder or aggregate is less than about 1:5.

9. The method of claim 1, wherein heating the preform further comprises heating the silicon carbide preceramic polymer above a pyrolysis temperature to pyrolyze the silicon carbide preceramic polymer into the silicon carbide matrix.

10. The method of claim 9, wherein heating the preform further comprises heating the silicon carbide matrix above a crystallization temperature to crystallize the silicon carbide matrix.

11. The method of claim 1, further comprising forming the refractory mixture by mixing the silicon carbide preceramic polymer and the refractory powder or aggregate.

12. The method of claim 1, wherein a melting point of the refractory powder or aggregate is greater than about 1500 degrees Celsius (° C.).

13. The method of claim 1, wherein the refractory component comprises an interior portion of a vessel for contacting molten metal.

14. The method of claim 1, wherein the refractory component comprises at least one of a ladle, a slide gate, or a liner.

15. A high temperature article of a foundry system, comprising:
a refractory component defining an oxidation-resistant surface configured to contact molten metal, wherein the refractory component comprises a refractory material, and wherein the refractory material comprises:
a polymer-derived silicon carbide matrix; and
at least one of a refractory powder or refractory aggregate in the silicon carbide matrix.

16. The high temperature article of claim 15, wherein the silicon carbide matrix comprises less than about 10 percent by volume of the refractory component.

17. The high temperature article of claim 15, wherein the refractory powder or aggregate comprises at least one of magnesia, alumina, silica, calcia, ferric oxide, titania, silicates, zirconia, or chamotte.

18. The high temperature article of claim 15, wherein a melting point of the refractory powder or aggregate is greater than about 1500 degrees Celsius (° C.).

19. The high temperature article of claim 15,
wherein the high temperature article comprises a vessel,
wherein the refractory component comprises an interior portion of the vessel, and
wherein the oxidation-resistant surface of the refractory component is configured to contact molten metal.

20. The high temperature article of claim 1, wherein the refractory component comprises at least one of a ladle, a slide gate, or a liner.
